(19) United States
(12) Patent Application Publication
(10) Pub. No.: US 2009/0160291 A1
(43) Pub. Date: Jun. 25, 2009

(54) PIEZOELECTRIC ACTUATOR

(75) Inventor: Osamu MIYAZAWA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/391,336

(22) Filed: Feb. 24, 2009

Related U.S. Application Data
(63) Continuation of application No. 11/728,601, filed on Mar. 26, 2007.

(30) Foreign Application Priority Data
Mar. 28, 2006 (JP) 2006-087516

(51) Int. Cl. H02N 2/14

(52) U.S. Cl. 310/317

(57) ABSTRACT

A piezoelectric actuator includes: a vibrator that includes a piezoelectric element, a first drive electrode and a second drive electrode, the piezoelectric element vibrated by a combination of at least two vibration modes including a first vibration mode and a second vibration mode, the first drive electrode applying a first drive signal that excites a vibration of the first vibration mode, the second drive electrode applying a second drive signal that excites a vibration of the second vibration mode; and a phase adjuster that adjusts a phase of at least one of the first and second drive signals.

This application is a continuation of U.S. patent application Ser. No. 11/728,601 filed on Mar. 26, 2007. This application claims the benefit of Japanese Patent Application No. 2006-087516 filed Mar. 28, 2006. The disclosures of the above applications are incorporated herein by reference.

### BACKGROUND

1. Technical Field

The present invention relates to a piezoelectric actuator that vibrates a vibrator by a combination of a plurality of vibration modes such as a longitudinal vibration and a bending vibration.

2. Related Art

Piezoelectric actuators typically vibrates a contact section of a vibrator along an elliptical trajectory to friction-drive a driven body (see, for instance, Document 1: Japanese Patent No. 2,722,211 (JP-A-2-41673), Document 2: Japanese Patent No. 3,192,028 (JP-A-6-327274), Document 3: JP-A-8-126359, and Document 4: JP-A-2001-286166. In a piezoelectric actuator that vibrates the vibrator using a combination of two vibration modes of a longitudinal vibration and a bending vibration, it is difficult to completely match resonance frequencies of the two vibration modes due to variable factors such as design values related to a shape of the vibrator, a characteristic of the vibrator, variation in manufacturing, a change over time of a friction-driving section, an electrically driving condition and the like, so that the piezoelectric actuator vibrates the vibrator at a uniform driving frequency that is different from the resonance frequencies. As a result of the drive at the uniform drive frequency, a vibration trajectory of the contacting section becomes elliptical.

Now, how the elliptical trajectory is made will be described with reference to FIGS. 9, 10, 11A and 11B. A vibrator 10 shown in FIG. 9 is rectangular and its front side is formed by a piezoelectric element. Provided on the piezoelectric element are a first drive electrode 11 arranged in a lengthwise direction at the center of the piezoelectric element, a pair of second and third drive electrodes 12, 13 arranged along one side of the first drive electrode 11 and another pair of second and third drive electrodes 12, 13 arranged on the other side of the first drive electrode 11, the second drive electrodes 12 arranged on a diagonal line and connected to each other by a lead wire, the third drive electrodes 13 arranged on the other diagonal line and connected to each other by a lead wire.

In the vibrator 10 described above, a first drive signal 14 is applied from a signal generating device 20 (an alternating-current power source) to the first drive electrode 11, a second drive signal 16 that is phase-delayed by a phase shifter 15 by 90 degrees relative to the first drive signal 14 is applied to the second drive electrodes 12 and a third drive signal (not shown) that is phase-inverted by a phase inverter 17 by 180 degrees relative to the second drive signal 16 is applied to the third drive electrodes 13, the drive signals applied at respective predetermined drive amplitudes and a uniform drive frequency. Then, the application of the drive signal to the first drive electrode 11 excites a longitudinal vibration along the lengthwise direction of the vibrator 10, while the applications of the drive signals to the second and third drive electrodes 12, 13 excite a bending vibration in a plane along a width direction of the vibrator 10.

FIG. 10 is a diagram showing an example of a vibration characteristic of the vibrator 10, where a resonance frequency of the longitudinal vibration excited in the vibrator 10 is displaced to be lower than a resonance frequency of the bending vibration. However, since the vibrator 10 cannot be driven at two different resonance frequencies, a frequency close to the resonance frequency of the longitudinal vibration is employed as a drive frequency in this example. As a result, as shown in FIGS. 10, 11A and 11B, a vibration waveform of the longitudinal vibration at a contact section 18 of the vibrator 10 is phase-delayed relative to the first drive signal 14 substantially by 90 degrees (+90 degrees), while a waveform of the bending vibration is phase-advanced by α degrees relative to a state that is phase-delayed relative to the second drive signal 16 by 90 degrees (−α degrees). As described above, the waveform of the bending vibration is phase-delayed relative to the waveform of the longitudinal vibration by 90-α degrees in total, which causes the vibration trajectory of the contact section 18 to be elliptical. In dispositions of the vibrator 10 and a driven body 19 as shown in FIG. 9, a long axis A1 and a short axis As of the elliptical vibration trajectory are inclined relative to a normal line N of the contact section 18 and the driven body 19.

Meanwhile, under a certain drive condition of the driven body 19, the vibration trajectory of the contact section 18 is desired to have a shape close to a perfect circle as shown by the dotted lines in FIGS. 1A and 1B rather than the elliptical trajectory or even when the vibration trajectory is elliptical, the long axis A1 and the short axis As of the vibration trajectory are desired not to be inclined relative to the normal line N. For example, with the perfectly circular vibration trajectory, a speed change during a time when the contact section 18 is in contact with the driven body 19 decreases, which reduces wear caused by the friction and thus realizes excellent durability. In addition, a feed amount of the driven body 19 in one cycle is f2 during the vibration along the perfectly circular trajectory, which is larger than a feed amount f1 during the vibration along the elliptical trajectory, thereby increasing a drive speed of the driven body 19. Although not shown, even with the elliptical trajectory, by arranging the long axis A1 in parallel with the normal line N, the feed amount can further be increased, thus further increasing the drive speed. In addition, by arranging the short axis As in parallel with the normal line N, a transfer torque can be greatly increased although the wear is accelerated, as compared to the arrangement in which the short axis As is inclined relative to the normal line N.

However, although Documents 1 to 4 disclose optimization of the vibration trajectory of the contact section, the driven body is driven only along the optimized one elliptical vibration trajectory. Accordingly, the arrangements disclosed in Documents 1 to 4 cannot satisfy requirements such as arbitrarily changing directions of the long and short axes (arbitrarily changing orientation of the vibration trajectory) to meet various drive conditions and driving the contact section along the perfectly circular vibration trajectory. In addition, to arrange the long and short axes of the vibration trajectory so as not to incline relative to the normal line, a positional relationship between the vibrator and the driven body requires to be adjusted, which limits design flexibility of dispositions of the vibrator and the driven body.

### SUMMARY

An advantage of some aspects of the invention is to provide a piezoelectric actuator capable of arbitrarily changing a shape or an orientation of a vibration trajectory of a contact section.

A piezoelectric actuator according to an aspect of the invention includes: a vibrator that includes a piezoelectric element, a first drive electrode and a second drive electrode, the piezoelectric element vibrated by a combination of at least two vibration modes including a first vibration mode and a second vibration mode, the first drive electrode applying a first drive signal that excites a vibration of the first vibration mode, the second drive electrode applying a second drive signal that excites a vibration of the second vibration mode; and a phase adjuster that adjusts a phase of at least one of the first and second drive signals.

According to the aspect of the invention, a phase-delay or a phase-advance (phase difference) of vibration waveforms caused by differences of the vibration modes can be eliminated or set to variable by adjusting in advance a phase of the drive waveform of the second drive signal. Accordingly, a shape or an orientation of a drive trajectory due to the phase difference can be arbitrarily changed by the adjustment, so that wears of the contact section and a driven body can be reduced or prevented and a drive speed of the driven body or a transfer torque to the driven body can be changed.

The piezoelectric actuator according to the aspect of the invention preferably includes a voltage adjuster that adjusts a voltage level of at least one of the first and second drive signals.

According to the aspect of the invention, the amplitude of the drive waveform can be changed after arbitrarily changing the shape or orientation of the vibration trajectory, so that the drive speed of the driven body and the transfer torque to the driven body can be greatly changed as needed.

### BRIEF DESCRIPTION OF THE DRAWINGS

The invention will be described with reference to the accompanying drawings, wherein like numbers reference like elements.

FIG. 1 is a block diagram showing a piezoelectric actuator according to a first exemplary embodiment of the invention;

FIG. 2 is a diagram showing waveforms of drive signals applied to the piezoelectric actuator;

FIG. 3 is a block diagram showing a piezoelectric actuator according to a second exemplary embodiment of the invention;

FIG. 4 is a diagram showing vibration trajectories of a contact section, where part (A) shows a vibration trajectory having a substantially perfect circular shape and part (B) shows a vibration trajectory having an elliptical shape;

FIG. 5 is a flowchart for explaining how the vibration trajectory and a rotation speed are automatically adjusted;

FIG. 6 is a block diagram showing a piezoelectric actuator according to a third exemplary embodiment of the invention;

FIG. 7 is a flowchart for explaining how a rotation speed is automatically adjusted;

FIG. 8 is a block diagram showing a modification of the invention;

FIG. 9 is an illustration for explaining a related art;

FIG. 10 is a diagram showing a relationship among vibration amplitudes, a frequency and a vibration phase of a longitudinal vibration and a bending vibration;

FIG. 11A is a diagram showing waveforms of the vibration amplitudes of the longitudinal vibration and the bending vibration; and

FIG. 11B is a diagram showing vibration trajectories of the longitudinal vibration and the bending vibration.

### DESCRIPTION OF EXEMPLARY EMBODIMENT(S)

### First Exemplary Embodiment

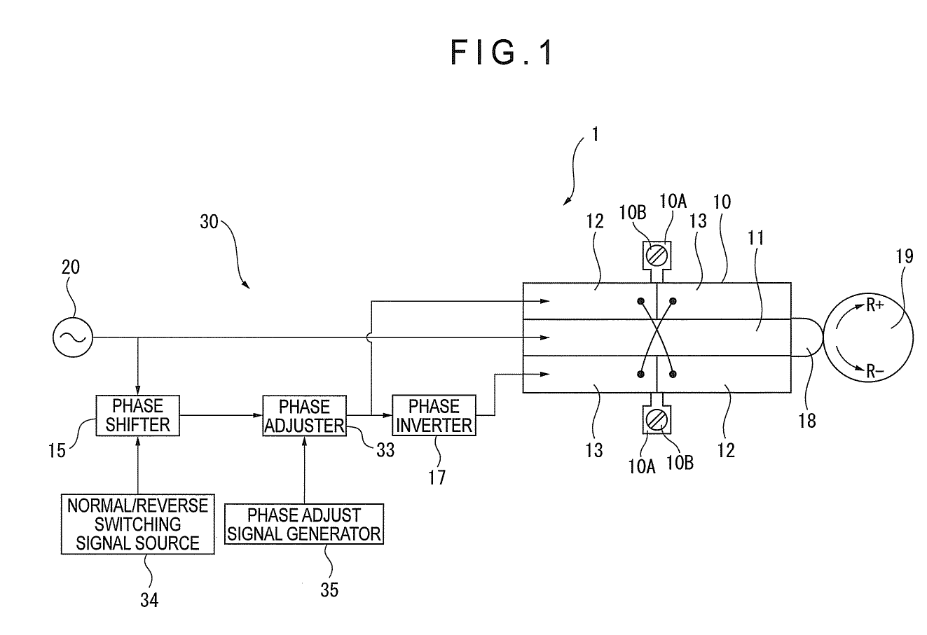

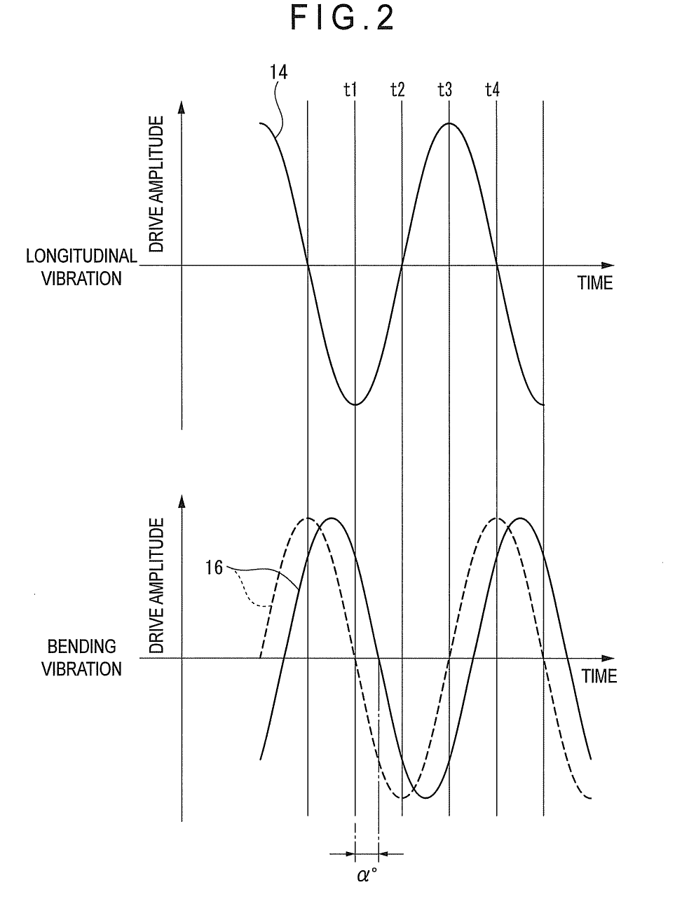

A first exemplary embodiment of the invention will be described with reference to the attached drawings. In the first exemplary embodiment, components the same as those described in RELATED ART are denoted respectively by the same reference symbols and the descriptions thereof will be omitted or simplified. FIG. 1 is a block diagram showing an arrangement of a piezoelectric actuator 1 according to the first exemplary embodiment. FIG. 2 shows waveforms of the first drive signal 14 and the second drive signal 16 that are applied to the piezoelectric actuator 1.

The piezoelectric actuator 1 includes the vibrator 10 that drives the driven body 19, the signal generating device 20 that generates an alternating voltage as a drive signal to be applied to the vibrator 10 and a driver circuit 30 that adjusts a drive signal from the signal generating device 20 and outputs the adjusted drive signal to the vibrator 10.

As described earlier, the vibrator 10 includes the first, second and third drive electrodes 11, 12, 13 that are provided on the piezoelectric element. Although not shown, the piezoelectric element is provided on each of front and back surfaces of a reinforcing plate (which is also called a shim plate). The piezoelectric element on the back surface side is also provided with first to third drive electrodes similar to the first to third drive electrodes 11 to 13 at positions overlapping with the first to third drive electrodes 11 to 13 in a manner plane-symmetrical thereto. Each of corresponding pairs of first drive electrodes 11, second drive electrodes 12 and third drive electrodes 13 is conducted. The reinforcing plate also serves as a terminal of the vibrator 10, which is grounded by a lead wire (not shown). Supporting sections 10A are integrally formed at the middle both lateral sides in a lengthwise direction of the reinforcing plate, the supporting sections 10A fixed to fixing sections (not shown) by screws 10B. The grounding may be performed by fixing the reinforcing plate to the fixing sections by screws instead of by using the lead wire.

The signal generating device 20 generates a drive signal having a predetermined frequency (first drive signal 14) and outputs the generated drive signal to the driver circuit 30. Although the drive signal is an analogue signal as an alternating voltage in the first exemplary embodiment, the drive signal may be a digital signal of a rectangular wave.

The driver circuit 30 includes the phase shifter 15, the phase inverter 17 and a phase adjuster 33, which are each formed by hardware or software. The phase shifter 15 phase-delays the drive signal from the signal generating device 20 by 90 degrees. Specifically, as shown in FIG. 2, the phase shifter 15 generates and outputs the second drive signal 16 (shown by the dotted line in FIG. 2) that is phase-delayed by 90 degrees from the first drive signal 14 for the longitudinal vibration that is substantially directly applied to the first drive electrode 11 from the signal generating device 20. The phase-delayed second drive signal 16 is applied to the second drive electrode of the piezoelectric element. The phase inverter 17 is formed by, for instance, an inverter circuit, which generates a third drive signal (not shown) that is phase-inverted by 180 degrees from the second drive signal 16 and applied to the third drive electrode 13.

By applying the first drive signal 14 to the first drive electrode 11, the second drive signal 16 to the second drive electrode 12 and the third drive signal to the third drive electrode 13, the vibrator 10 is excited to vibrate in two vibration modes of the longitudinal vibration and the bending vibration, which causes the contact section 18 to vibrate along an elliptical vibration trajectory, resulting in rotating the driven body 19 in R+direction (normal rotation).

Meanwhile, the phase shifter 15 is connected to a normal/reverse switching signal source 34 that outputs a switch signal. In response to the switch signal from the normal/reverse switching signal source 34, the phase shifter 15 phase-advances the second drive signal 16 by 90 degrees relative to the first drive signal 14 instead of phase-delaying the second drive signal 16 by 90 degrees relative to the first drive signal 14. As a result, the second drive signal 16 that has been phase-advanced by 90 degrees is applied to the second drive electrode 12 and the third drive signal that has been phase-inverted relative to this second drive signal 16 is applied to the third drive electrode 13, which causes the contact section 18 to vibrate along an elliptical trajectory in a direction different from the above case, resulting in rotating the driven body 19 in R-direction (reverse rotation). In short, the normal/reverse switching signal source 34 serves as a switch for switching the rotation direction of the driven body 19.

The phase adjuster 33 is formed by a suitable combination of an inductance element, a capacitance element and the like in the first exemplary embodiment where the drive signal having an analogue waveform is employed. The phase adjuster 33 arbitrarily changes or adjusts the phase of the second drive signal 16, through which the phase adjuster 33 can also change or adjust the phase of the third drive signal as an inverted drive signal of the second drive signal 16. In an arrangement in which the drive signal has a digital waveform, the phase adjuster 33 may be formed by a counter or the like.

The phase adjuster 33 is connected to a phase-adjusting signal generator 35. The phase-adjusting signal generator 35 is connected to a personal computer or the like in which a predetermined phase-adjusting program operates, the phase-adjusting signal generator 35 outputting a command signal for phase adjustment in response to an operation at a numeric keypad or an operation at a dial (not shown) provided to the piezoelectric actuator 1. The phase adjustment signal allows the phase adjuster 33 to phase-advance or phase-delay the second drive signal 16 (the third drive signal) by a desired angle. FIG. 2 shows a waveform of the second drive signal 16 that is phase-delayed by α degrees (shown by the solid line in FIG. 2). In this case, the third drive electrode is also phase-delayed by α degrees.

At this time, the phase difference of α degrees corresponds to the phase advance of the vibration waveform of the bending vibration as mentioned earlier. Accordingly, by phase-delaying the second drive signal 16 by the advance of the vibration waveform of the bending vibration, when the vibrator 10 is actually driven, the phase advance by α degrees of the vibration waveform of the bending vibration can be eliminated and phase-delayed exactly by 90 degrees relative to the vibration waveform of the longitudinal vibration.

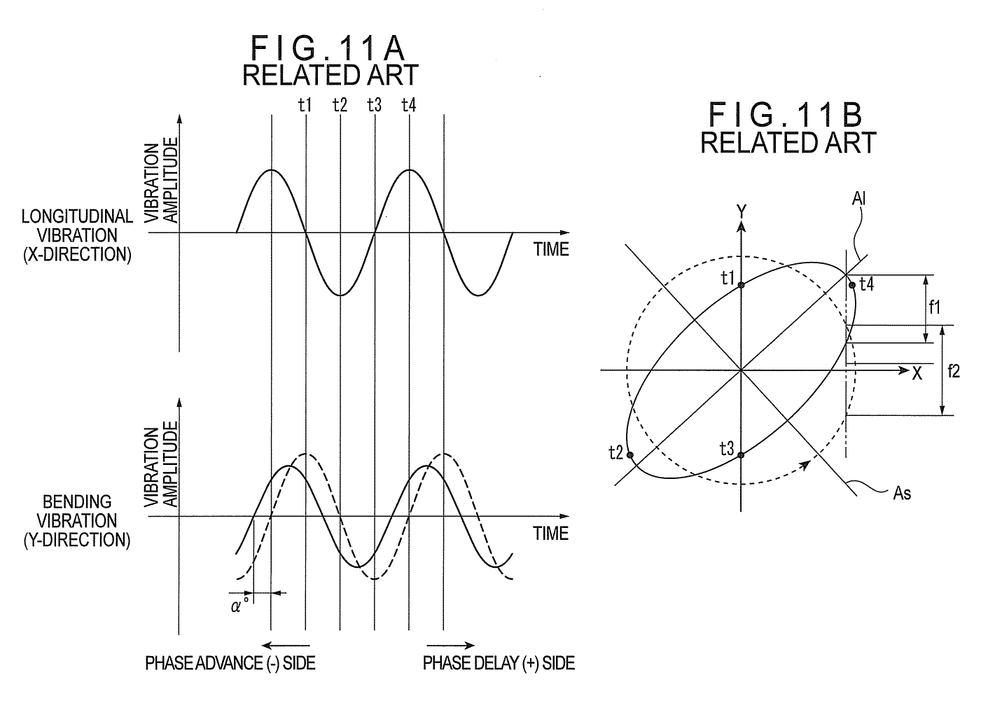

Accordingly, in the first exemplary embodiment where amplitudes of the first drive signal 14, the second drive signal 16 and the third drive signal are uniform and consistent, by designing an aspect ratio or the like of the vibrator 10 such that the vibration amplitudes in the longitudinal vibration and the bending vibration become substantially uniform, the vibration trajectory of the contact section 18 becomes a substantially perfect circle shape as shown by the dotted line in FIG. 11B. Specifically, the elliptical vibration trajectory of the related art that has the long axis Ai and short axis As inclined relative to the normal line N is changed to have the substantially perfect circle shape such that the long axis A1 overlaps with the X-axis orthogonal to the normal line N and the short axis As overlaps with the Y-axis parallel to the normal line N.

Then, by forming the vibration trajectory to have the substantially perfect circle shape, a speed change during a time when the contact section 18 is in contact with the driven body 19 can be reduced as compared to the related art, which reduces or prevents wears of the contact section 18 and the driven body 19. In addition, by forming the vibration trajectory of the contact section 18 to have the substantially perfect circle shape, the feed amount f2 of the driven body 19 can be increased as compared to the feed amount f1 of the related art, thereby increasing the drive speed.

### Second Exemplary Embodiment

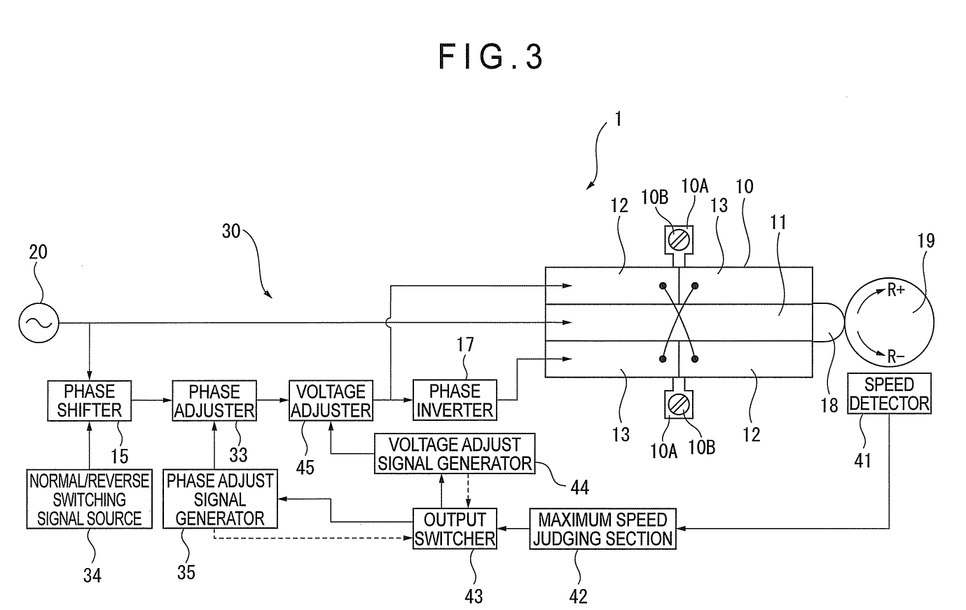

FIG. 3 is a block diagram showing an arrangement of the piezoelectric actuator 1 according to a second exemplary embodiment of the invention. Note that components the same as those described in RELATED ART and in the first exemplary embodiment are denoted respectively by the same reference symbols and the descriptions thereof will be omitted or simplified, which is also applied to a later-described third exemplary embodiment.

The driver circuit 30 of the piezoelectric actuator 1 in the second exemplary embodiment includes, in addition to the components of the first exemplary embodiment, a speed detector 41, a maximum speed judging section 42, an output switcher 43, a voltage-adjusting signal generator 44 and a voltage adjuster 45, the driver circuit 30 being so arranged as to automatically perform the above-described phase adjustment of the second drive signal 16 (FIG. 2) and an adjustment of a drive amplitude (i.e., voltage level) of the second drive signal 16.

The speed detector 41 is formed by, for instance, an encoder, which detects a rotation speed of the driven body 19 and outputs a detection signal to the maximum speed judging section 42.

The maximum speed judging section 42 outputs to the output switcher 43 a command signal for a signal generation in response to the input of the detection signal and judges whether or not the driven body 19 is driven at a maximum speed.

The output switcher 43 serves as a switch for switching an output destination of the signal generation command signal, specifically, whether the command signal is output to the phase-adjusting signal generator 35 or to the voltage-adjusting signal generator 44. A switch signal (shown by the dotted line in FIG. 3) is output to the output switcher 43 from the phase-adjusting signal generator 35 or the voltage-adjusting signal generator 44.

The voltage-adjusting signal generator 44 generates a command signal for a voltage adjustment that adjusts a magnitude of a voltage level (i.e., drive amplitude) based on the signal generation command signal, the voltage-adjusting signal generator 44 outputting the generated command signal to the voltage adjuster 45. Note that the phase-adjusting signal generator 35 to which a similar signal generation command signal is input automatically generates a command signal for a phase adjustment based on the input command signal and outputs the generated phase adjustment command signal to the phase adjuster 33.

The voltage adjuster 45 adjusts the magnitude of the drive amplitude of the second drive signal 16 that has been phase-adjusted based on the command signal for the voltage adjustment. As a result, the voltage level of the third drive electrode which has been phase-inverted is also adjusted.

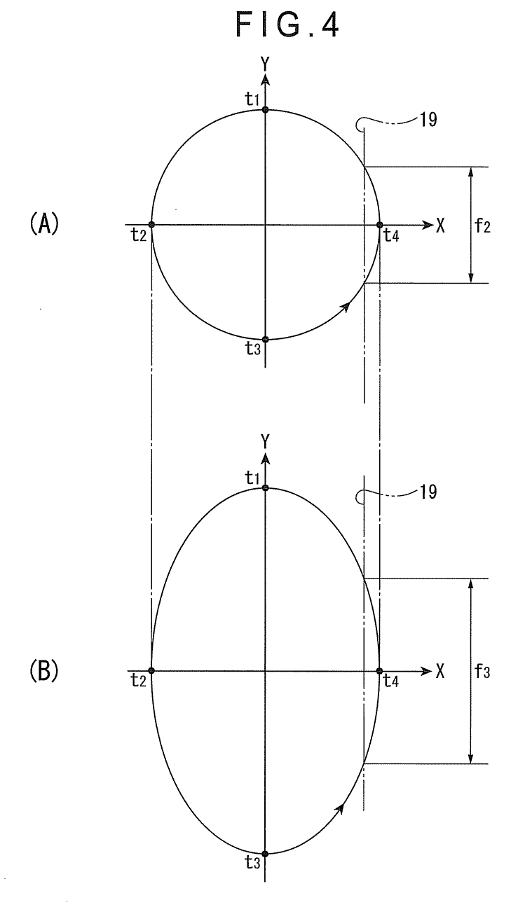

In the second exemplary embodiment as described above, the elliptical vibration trajectory of the related art as shown in FIG. 11B is automatically adjusted to be the vibration trajectory of the substantially perfect circle shape as shown in part (A) in FIG. 4. In addition, as shown in part (B) in FIG. 4, by, for instance, increasing only the vibration amplitude in the Y-axis direction without changing the vibration amplitude in the X-axis direction to further increase a feed amount f3, the drive speed can further be increased.

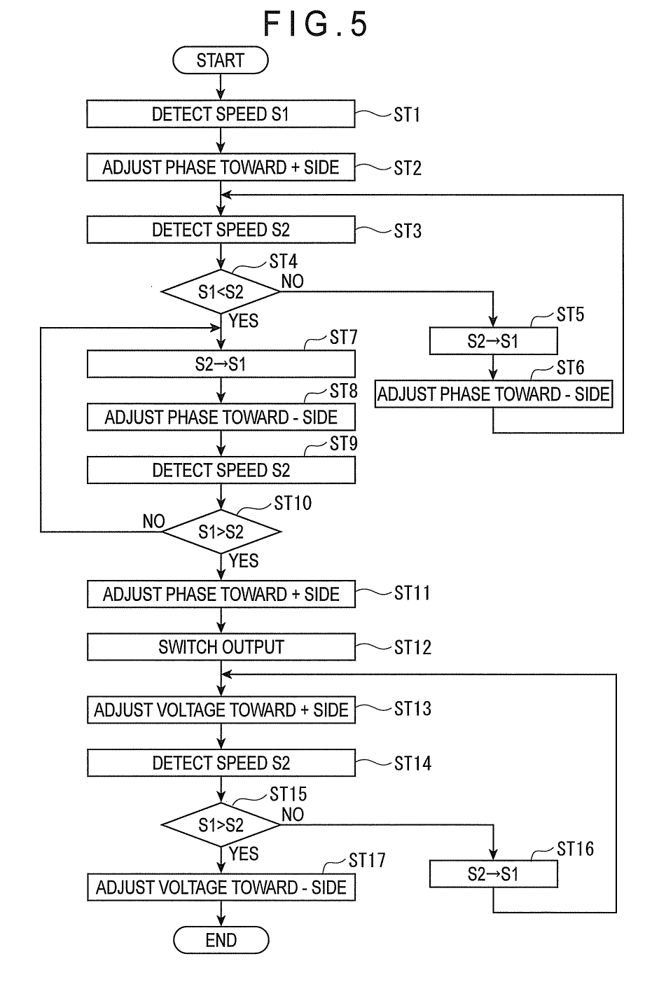

This will be described with reference to the flowchart shown in FIG. 5.

First, by applying the first drive signal 14 shown in FIG. 2 to the first drive electrode 11, the second drive signal 16 (shown by the dotted line) of the related art to the second drive electrode 12 and the third drive signal that is phase-inverted relative to the second drive signal 16 to the third drive electrode 13, the driven body 19 is driven. In this state, the speed detector 41 detects the rotation speed of the driven body 19 as a speed S1 (ST1).

Then, the maximum speed judging section 42 stores the speed S1 while outputting the signal generation command signal to the output switcher 43. In this step, the output switcher 43 is so set as to feed the command signal to the phase-adjusting signal generator 35, and thus the command signal is output to the phase-adjusting signal generator 35. In response to the input of the command signal, irrespective of the speed S1 of the driven body 19, the phase-adjusting signal generator 35 generates a command signal for adjusting the phase of the second drive signal 16 toward the +side (i.e., delaying the phase) by a predetermined angle and outputs the generated command signal to the phase adjuster 33. The phase adjuster 33 makes an adjustment such that the second drive signal 16 is phase-delayed relative to the first drive signal 14 by the predetermined angle based on the command signal. Accordingly, the third drive signal is also phase-delayed (ST2). Note that the description of the third drive signal will be omitted because the third drive signal behaves similarly to the second drive signal 16.

Thereafter, the speed detector 41 detects the rotation speed of the driven body 19 as a speed S2 and outputs a detection signal to the maximum speed judging section 42 (ST3). The maximum speed judging section 42 compares the speed S1 before the phase-delaying and the speed S2 after the phase-delaying (ST4). When the speed S2 after the phase-delaying is smaller than the speed S1, the maximum speed judging section 42 stores the speed S2 as the speed S1 (ST5) and then outputs the signal generation command signal to the phase-adjusting signal generator 35 via the output switcher 43. Upon receiving the signal generation command signal, the phase-adjusting signal generator 35 generates a command signal for adjusting the phase of the second drive signal 16 toward the −side (i.e., advancing the phase) by a predetermined angle and outputs the generated command signal to the phase adjuster 33. The phase adjuster 33 phase-advances the second drive signal 16 relative to the first drive signal 14 by the predetermined angle based on the command signal, thereby restoring the phase of the second drive signal 16 (ST6). With the arrangement, the rotation speed can be prevented from being shifted toward a low speed.

Returning to ST3, the speed detector 41 again detects the rotation speed of the driven body 19 as the speed S2. Since the speed S2 is inevitably larger than the speed S1 in the following step ST4, process proceeds to ST7. The maximum speed judging section 42 stores the speed S2 as the speed S1 (ST7). Then, the phase-adjusting signal generator 35 again generates a command signal for adjusting the phase of the second drive signal 16 toward the −side by a predetermined angle and the phase adjuster 33 phase-advances the second drive signal 16 based on the command signal (ST8). The speed detector 41 detects the rotation speed as the speed S2 (ST9) and the maximum speed judging section 42 compares the speed S2 and the speed S1 (ST10). In this step, since the speed S2 is inevitably larger than the speed S1, the process returns to ST7 and the steps ST7 to ST10 are repeated. With the arrangement, the phase is gradually adjusted toward the −side and the rotation speed of the driven body 19 is gradually increased, which causes the vibration trajectory of the contact section 18 to change from the elliptical shape to the perfect circle shape as shown in part (A) in FIG. 4.

However, when the phase is continuously adjusted toward the −side, the vibration trajectory is further changed from the perfect circle shape to an elliptical shape with its inclination direction different from that of the original elliptical shape, so that the vibration amplitude of the longitudinal vibration is decreased and the rotation speed is lowered. Meanwhile, in ST 10, when it is judged that the speed S2 is smaller, the vibration trajectory is in such a state. In such case, the phase adjuster 33 adjusts the phase toward the +side so as to return the phase to the phase of the preceding stage and maintains the last maximum rotation speed (ST11). In short, the vibration trajectory can be automatically maintained to be the substantially perfect circle shape. The phase adjuster 33 outputs the switch signal to the output switcher 43 to switch the output switcher 43 in such a manner that the command signal from the maximum speed judging section 42 is output to the voltage-adjusting signal generator 44.

Thereafter, the voltage-adjusting signal generator 44 outputs a command signal for adjusting the voltage of the second drive signal 16 toward the +side (i.e., increasing the voltage) by a predetermined magnitude, and the voltage adjuster 45 accordingly increases the voltage level of the second drive signal 16 based on the command signal (ST13). Then, the speed detector 41 detects the rotation speed as the speed S2 (ST14) and the maximum speed judging section 42 compares the speed S1 that has been stored as the last maximum rotation speed and the speed S2 (ST15). When the voltage level of the second drive signal 16 is increased, since the vibration amplitude of the bending vibration increases, the vibration trajectory becomes an elliptical shape with the long axis A1 overlapping with the Y-axis, which increases the feed amount f3 and results in a great increase of the drive speed. Accordingly, in the comparison in ST15, the speed S2 is inevitably larger, and the process proceeds to ST16. The maximum speed judging section 42 then stores the speed S2 as the speed S1 (ST16). The steps ST13 to ST16 are repeated to further increase the rotation speed toward a high speed side.

However, the rotation speed is not infinitely increased. A maximum vibration amplitude of the bending vibration is limited by the shape and size of the vibrator 10, when the voltage level is continued to be increased, the rotation speed becomes consistent or even decreases. Accordingly, when it is judged in ST15 that the rotation speed is in such a state, the voltage adjuster 45 adjusts the voltage level of the second drive signal 16 toward the −side (i.e., decreasing the voltage level) so as to return the voltage level of the preceding stage and maintains the rotation speed at this time as the maximum rotation speed (ST17). Owing to the operation, the driven body 19 can be automatically driven at the maximum rotation speed.

### Third Exemplary Embodiment

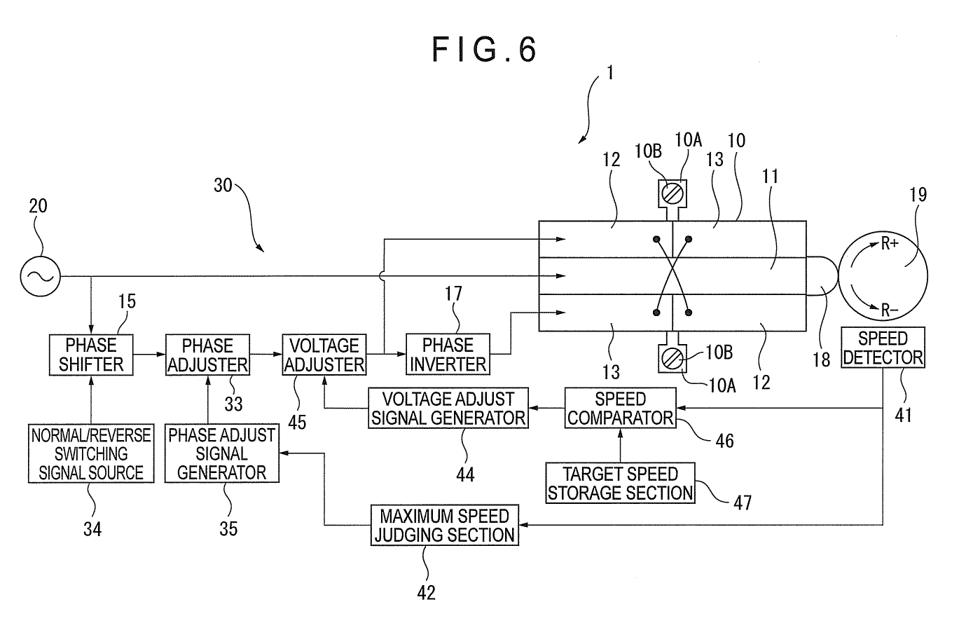

The driver circuit 30 shown in FIG. 6 of the third exemplary embodiment is provided with, as a comparator of the rotation speeds of the driven body 19, a speed comparator 46 that compares a preset target speed S and the actual speed S2 detected by the speed detector 41 in addition to the maximum speed judging section 42 similar to that of the second exemplary embodiment. The speed comparator 46 is connected to a target speed storage section 47 that is formed by a suitable memory element or the like. As described above, the target speed storage section 47 stores the preset target speed S.

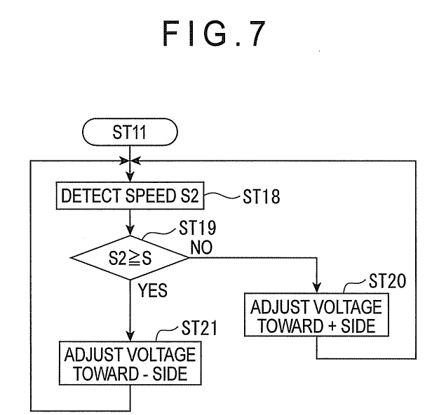

In the third exemplary embodiment, similarly to the second exemplary embodiment, the vibration trajectory of the contact section 18 can be automatically adjusted to be the substantially perfect circle shape by the steps ST1 to ST11. Further, the rotation speed can be maintained to be the target speed S after ST11 as shown in FIG. 7. First, after ST11 in FIG. 5, the speed detector 41 detects the rotation speed as the speed 2 (ST18). Next, the speed comparator 46 compares the target speed S stored in the target speed storage section 47 and the speed S2 (ST19). When the speed S2 is smaller than the target speed, the voltage-adjusting signal generator 44 outputs a command signal and the voltage adjuster 45 increases the voltage level by a predetermined magnitude based on the command signal (ST20). By repeating the steps ST18 and ST19, the speed S2 automatically reaches the target speed S. When the speed S2 reaches or overreaches the target speed S, the voltage adjuster 45 decreases the voltage level by a predetermined magnitude (ST21). By repeating the steps ST18 to ST21, the speed S2 can be maintained to be around the target speed.

It should be noted that the invention is not limited to the exemplary embodiments above, but includes modifications and improvements as long as advantages of some aspects of the invention can be achieved.

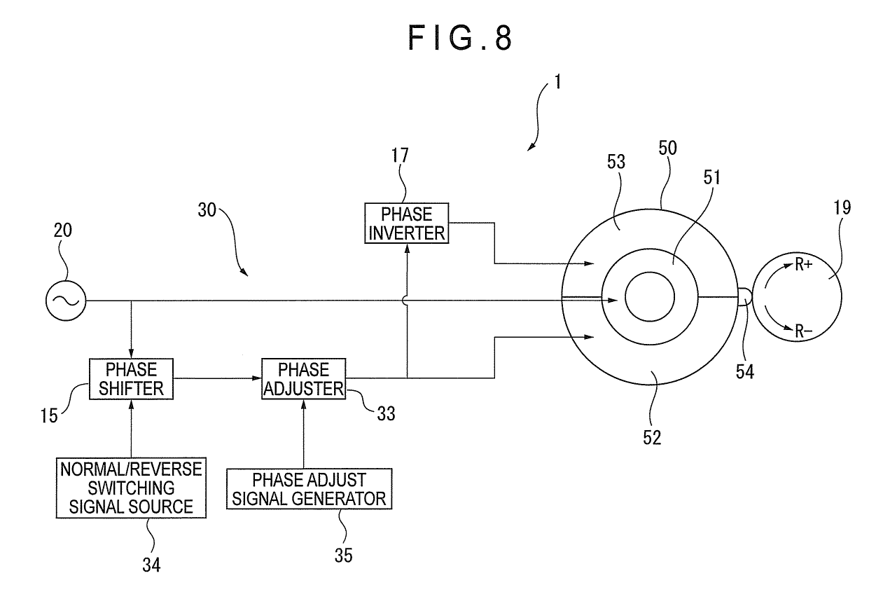

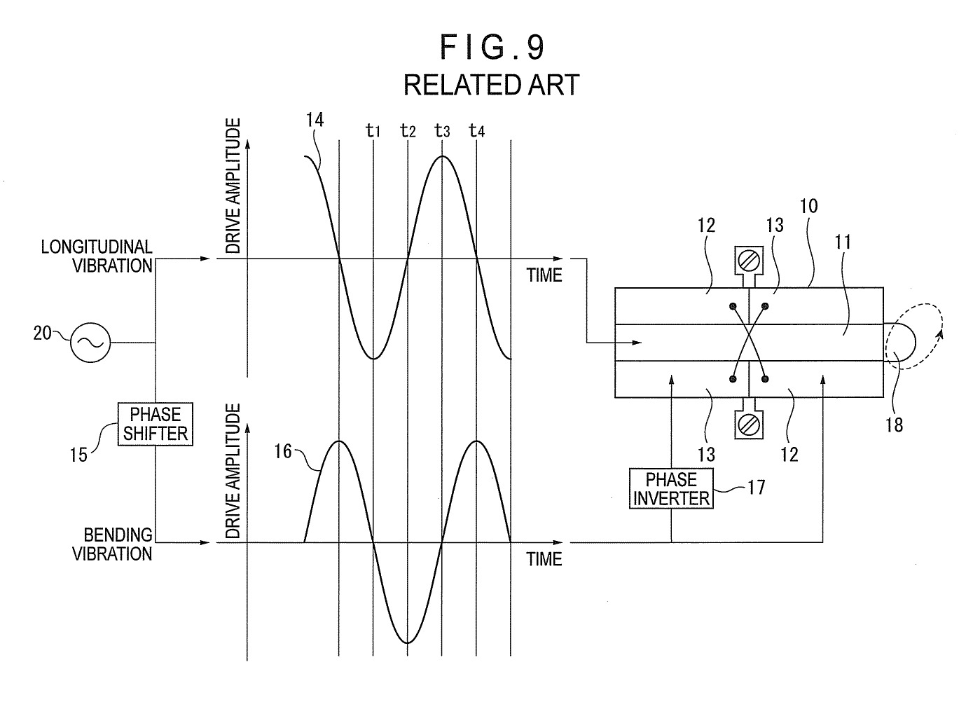

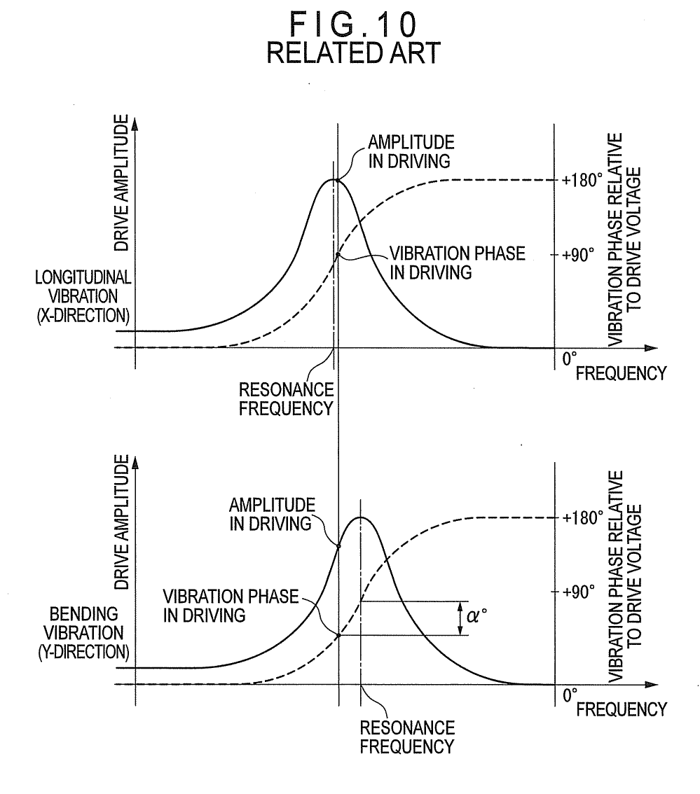

For example, although the rectangular vibrator 10 having the first to third electrodes 11 to 13 is employed in the exemplary embodiments above, a circular vibrator 50 as shown in FIG. 8 may be employed. The vibrator 50 includes a first drive electrode 51 provided so as to surround an opening at the center thereof and second and third electrodes 52, 53 circumferentially provided on an outer side of the first drive electrode 51. The first to third drive electrodes 51 to 53 respectively correspond to the first to third drive electrodes 11 to 13 in the exemplary embodiments above. By applying a first signal to the first drive electrode 51, the longitudinal vibration is excited, while by applying second and third drive signals that are phase-inverted to each other to the second and third drive electrodes 52, 53, a lateral vibration is excited in a direction orthogonal to the longitudinal vibration in a plane, thereby generating a vibration trajectory having an elliptical shape or a substantially perfect circle shape in the contact section 54. Although the driver circuit 30 shown in FIG. 8 has the arrangement same as that of the first exemplary embodiment, a combination of the circular vibrator 50 and the driver circuit 30 in the second or third exemplary embodiment may also be employed.

Although the phase or the voltage level of the second drive signal 16 is adjusted in the exemplary embodiments above, the arrangement is not limited thereto. It may be so arranged that the first drive signal 14 is adjusted or both of the first and second drive signals 14, 16 are adjusted.

The second and third drive electrodes 12, 13 are provided and the drive signals that are phase-inverted to each other are applied to the second and third drive electrodes 12, 13 in the exemplary embodiments above. However, even when only one of the second and third drive electrodes 12, 13 is provided, a predetermined vibration trajectory can be generated in the contact section 18 and the driven body 19 can be driven, so that such an arrangement is also included in the invention.

What is claimed is:

1. A piezoelectric actuator, comprising:
a first drive electrode that applies a first drive signal exciting a longitudinal vibration,
a second drive electrode that applies a second drive signal exciting a bending vibration,
a phase adjusting signal generator that outputs a command signal for phase adjustment, and
a phase adjuster that changes a phase of the second drive signal by inputting the command signal for phase adjustment.

2. A piezoelectric actuator, comprising:
a first drive electrode that applies a first drive signal exciting a longitudinal vibration,
a second drive electrode that applies a second drive signal exciting a bending vibration,
a phase adjusting signal generator that outputs a command signal for phase adjustment, and
a phase adjuster that changes a phase of the first drive signal by inputting the command signal for phase adjustment.

3. A piezoelectric actuator, comprising:
a first drive electrode that applies a first drive signal exciting a longitudinal vibration,
a second drive electrode that applies a second drive signal exciting a bending vibration,
a phase adjusting signal generator that outputs a command signal for phase adjustment, and
a phase adjuster that changes a phase of the first drive signal and second drive signal by inputting the command signal for phase adjustment.

4. The piezoelectric actuator according to claim 1, further comprising:
a driven body that rotates by the longitudinal vibration and the bending vibration, and
a speed detector that detects a rotation speed of the driven body,
wherein the phase adjusting signal generator outputs the command signal for phase adjustment based on a detection signal detected by the speed detector.

5. The piezoelectric actuator according to claim 1, further comprising:
a driven body that rotates by the longitudinal vibration and the bending vibration,
a speed detector that detects a rotation speed of the driven body,
a voltage adjusting signal generator that outputs a command signal for voltage adjustment based on a detection signal detected by the speed detector, and
a voltage adjuster that changes a voltage of the second drive signal by inputting the command signal for voltage adjustment.

6. The piezoelectric actuator according to claim 1, further comprising:
a driven body that rotates by the longitudinal vibration and the bending vibration,
a speed detector that detects a rotation speed of the driven body,
a speed comparator that compares a preset speed and the rotation speed of the driven body detected by the speed detector, and
a voltage adjuster that increase a voltage of the second drive signal in case of the rotation speed is smaller than the preset speed.

7. The piezoelectric actuator according to claim 6, wherein the voltage adjuster that decreases a voltage of the second drive signal in case of the rotation speed is bigger than the preset speed.
